(19) United States
(12) Patent Application Publication
(10) Pub. No.: US 2006/0110196 A1
(43) Pub. Date: May 25, 2006

(54) Multicolor security border for documents

(75) Inventor: Robert I. Diamond, Woodinville, WA (US)

Correspondence Address: JENKENS & GILCHRIST, PC, 1445 ROSS AVENUE, SUITE 3200, DALLAS, TX, 75202, US

(73) Assignee: Diamond Security, Inc.

(21) Appl. No.: 10/995,705

(22) Filed: Nov. 23, 2004

(51) Int. Cl. G03G 21/00

(52) U.S. Cl. 399/366

(57) ABSTRACT

A document having enhanced security for deterring the fraudulent photocopying of the subject document by use of a multicolor security border. At least two patterns are printed in the border area of a document, where each of the patterns are a different color and different in color from the background of the document.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A COMPACT DISK APPENDIX

Not applicable.

### BACKGROUND OF THE INVENTION

A major problem within the document industry is the increasing risks arising from the copying of documents by unauthorized individuals. These risks have increased due to the improved technology in the areas of copiers, computer aided design and desk top publishing. Advancements in these areas have created the ability to duplicate documents to such a high degree of accuracy that an individual receiving the document has difficulty in determining if the document is fraudulent.

### BRIEF SUMMARY OF THE INVENTION

The foregoing and other problems are overcome by the present invention. The present invention relates to enhanced security for deterring the fraudulent photocopying of a document by use of a multicolor security border. The present invention includes at least two patterns printed in the border area of a document, where each of the patterns is a different color. The colors of the patterns vary by differences in hue, saturation, or value, or some combination thereof. The color in a particular pattern may also change along its length through differences in hue, saturation, or value, or some combination thereof. The patterns intersect, interweave, are interposed, or are completely independent of one another. The patterns are geometric, curvilinear, alphanumeric, or any other type of design. The patterns are included along the entire border of a document or merely along some portion of the border.

### BRIEF DESCRIPTION OF THE DRAWINGS

A more complete understanding of the present invention may be obtained by reference to the following Detailed Description when taken in conjunction with the accompanying Drawings wherein:

FIG. 1a is an illustration of the front side of a document utilizing the multicolor security border of the present invention;

FIG. 1b is an illustration of the multicolor security border comprising a magnified portion of the document of FIG. 1;

FIG. 2a is an illustration of the front side of a document utilizing the multicolor security border of the present invention on at least a portion of one edge of the document;

FIG. 2b is an illustration of the front side of a document utilizing the multicolor security border of the present invention on at least a portion of two edges of the document;

FIG. 2c is an illustration of the front side of a document utilizing the multicolor security border of the present invention on at least a portion of three edges of the document;

FIG. 3 is an illustration of the front and back side of a document utilizing the multicolor security border of the present invention;

FIG. 4a is an illustration of the magnified multicolor security border comprising two intersecting patterns;

FIG. 4b is an illustration of the magnified multicolor security border comprising two interwoven patterns;

FIG. 4c is an illustration of the magnified multicolor security border comprising two interposed patterns;

FIG. 4d is an illustration of the magnified multicolor security border comprising two independent patterns;

FIG. 5a is an illustration of the magnified multicolor security border comprising a geometric pattern and a curvilinear pattern;

FIG. 5b is an illustration of the magnified multicolor security border comprising a curvilinear pattern and an alphanumeric pattern;

FIG. 5c is an illustration of the magnified multicolor security border comprising shapes;

FIG. 5d is an illustration of the magnified multicolor security border comprising patterns that do no repeat along the length of the pattern;

FIG. 6 is an illustration of the front side of a document utilizing the multicolor security border of the present invention where the color of a pattern in the border gradually changes.

### DETAILED DESCRIPTION OF THE INVENTION

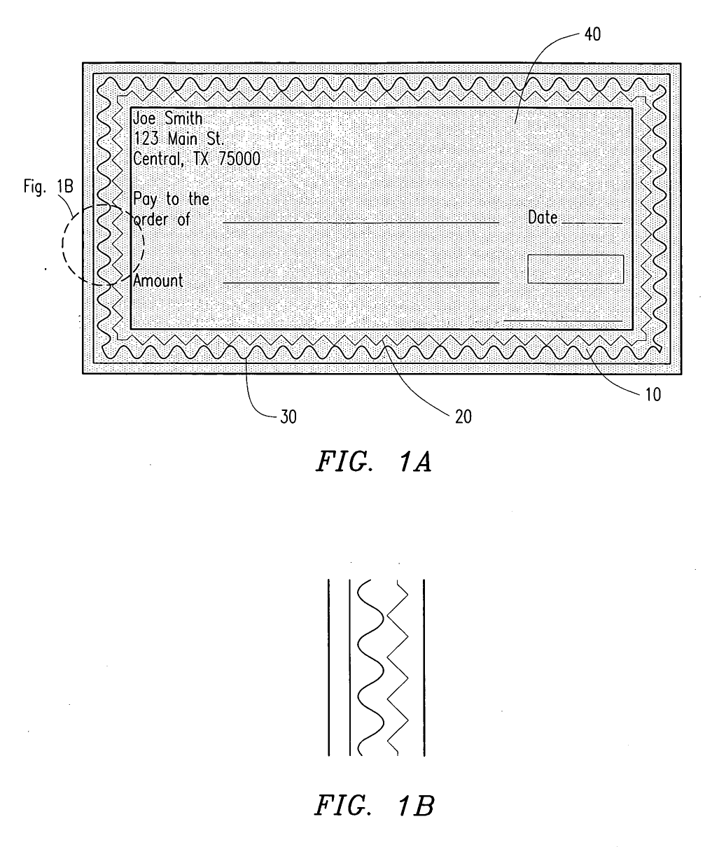

Referring now to the Drawings, and more particularly to FIG. 1a, there is illustrated the front side of a document, such as a check utilizing the multicolor security border of the present invention. The border area 10 on the check includes at least two patterns, pattern 20 and pattern 30 that are each a different color from one another and are each a different color from the check background.

This multicolor security border protects documents from being copied on a majority of existing copying systems because it makes it more difficult to reproduce the document than a single color.

While FIG. 1a illustrates a check, it is to be understood that the present invention is applicable to any type of document or paper. The documents of particular interest are those documents which have a high incidence of reproduction for fraudulent purposes. The present invention is applicable to all negotiable instruments, such as personal checks, cashier's checks and traveler's checks. The present invention is also applicable to documents such as pharmaceutical prescriptions, contracts, letters, deeds, wills, bills of exchange, certificates of deposit, warrants, stocks, bonds, lottery tickets, sweepstakes, raffles, prizes and awards. The present invention is further applicable to documents used for identification purposes, such as driver's licenses, passports, and employee identification badges.

The colors and differences in color of the multicolor patterns and the document background of the present invention can be defined by the Hue Saturation Value model (HSV), which is well known in the prior art. According to the HSV model, colors and differences in color are specified by three color parameters, the hue, the saturation, and the value. The present invention utilizes the HSV model to specify distinctions between the colors of the multicolor patterns and the document background. It will, of course, be understood that any other model for specifying differences in color, shade or hue could be used.

While FIG. 1a illustrates multicolor patterns that traverse substantially along the entire length of the border of one face of the check (i.e., the multicolor pattern runs along substantially all four edges of the front face of the check), it is to be understood that the present invention includes applying the multicolor patterns of the present invention to any portion of the border of either face or both faces of any document.

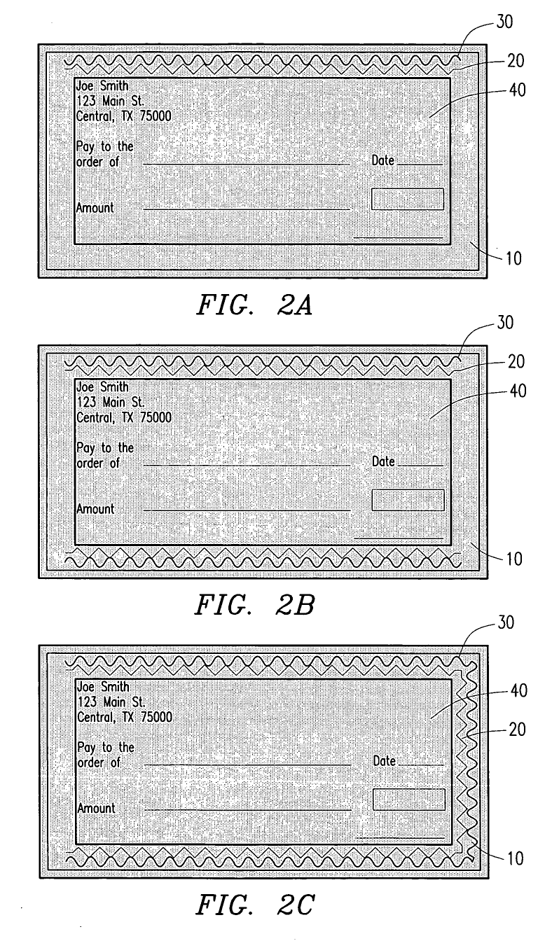

An alternate embodiment of the present invention includes the multicolor patterns along one edge of a document (see FIG. 2a). The multicolor patterns can traverse substantially the entire length of one edge on one face of a document, or only a portion of one edge on one face of a document. Alternatively, the multicolor patterns can traverse substantially the entire length of one edge on both faces of a document, or only a portion of one edge on both faces of a document. Alternatively, the multicolor patterns can traverse substantially the entire length of one edge on one face of a document and only a portion of one edge on the other face of the document. The edges on both faces of a document with the multicolor patterns may be symmetrical or non-symmetrical (i.e., the multicolor patterns on the two faces may be the same styles and colors or different styles and colors, and the multicolor patterns may be of different lengths on the two faces).

Another alternate embodiment of the present invention includes the multicolor patterns along two edges of a document (see FIG. 2b). The multicolor patterns can traverse substantially the entire length of two edges on one or both faces of the document, or only a portion of two edges on one or both faces of the document, or some combination thereof. The two edges with the multicolor patterns may be adjacent or non-adjacent. The two edges with the multicolor patterns may be symmetrical or non-symmetrical (i.e., the multicolor patterns on the two edges may be the same styles and colors or different styles and colors, and the multicolor patterns may be of different lengths on the two edges).

Another alternate embodiment of the present invention includes the multicolor patterns along three edges of a document (see FIG. 2c). The multicolor patterns can traverse substantially the entire length of three edges on one or both faces of the document, or only a portion of three edges on one or both faces of the document, or some combination thereof. The edges with the multicolor patterns may be symmetrical or non-symmetrical (i.e., the multicolor patterns on the edges may be the same styles and colors or different styles and colors, and the multicolor patterns may be of different lengths on the edges).

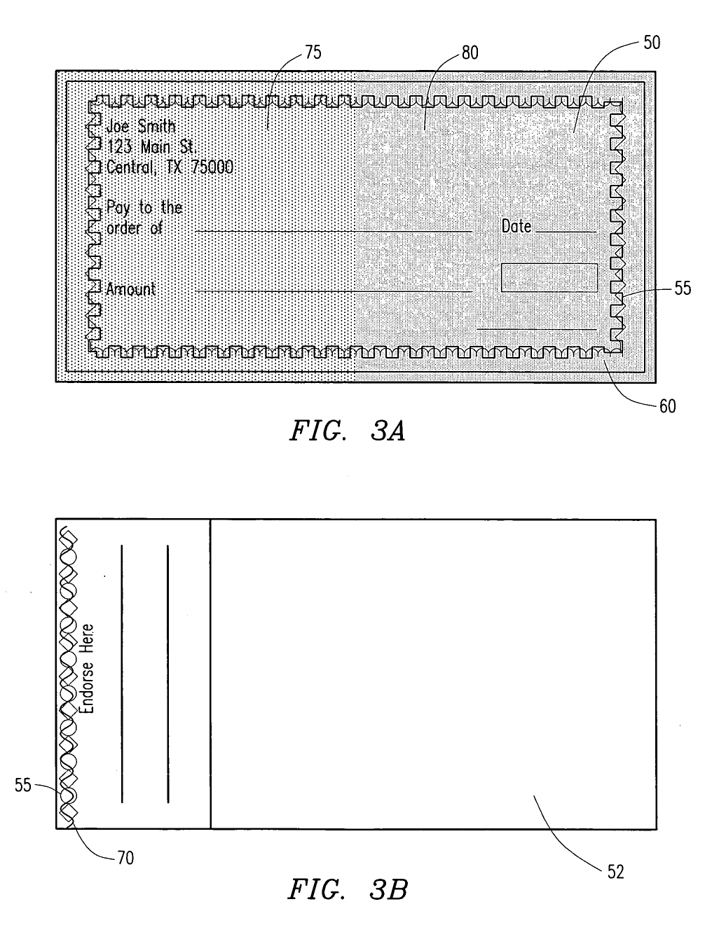

Another alternate embodiment of the present invention includes the multicolor patterns along all four edges of a document (see FIG. 1a and 3). The multicolor patterns can traverse substantially the entire length of four edges on one or both faces of the document, or only a portion of four edges on one or both faces of the document, or some combination thereof. The edges with the multicolor patterns may be symmetrical or non-symmetrical (i.e., the multicolor patterns on the edges may be the same styles and colors or different styles and colors, and the multicolor patterns may be of different lengths on the edges).

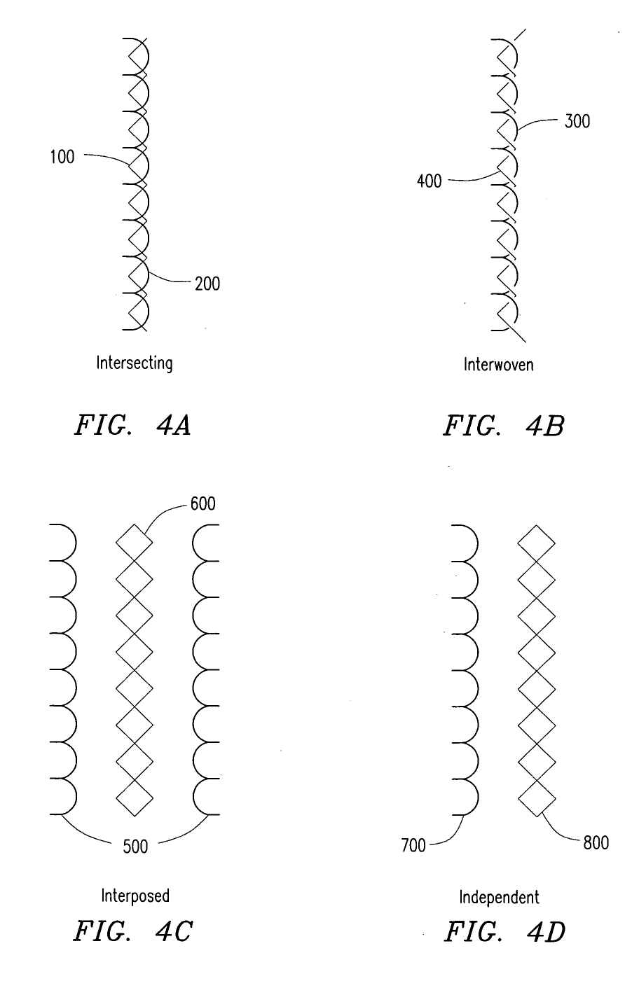

The present invention includes applying any number of patterns to the border area, so long as there are at least two patterns with colors that each differ from one another and from the document background color. Further, the present invention includes, in addition to independent multicolor patterns as illustrated in FIG. 1, multicolor patterns that intersect one another, are interwoven with one another, or are interposed between one another. FIG. 4a illustrates multicolor patterns that intersect. The two patterns in FIG. 4a intersect because portions of Pattern 100 are printed directly on portions of Pattern 200. Where the two patterns cross each other, the color of one pattern is printed directly on the color of the other pattern. FIG. 4b illustrates interwoven multicolor patterns. The two patterns in FIG. 4b are interwoven because there are gaps where the two patterns 300 and 400 cross, such that no portion of either pattern is printed directly on any portion of the other pattern to give the effect of weaving. FIG. 4c illustrates interposed multicolor patterns. The two patterns in FIG. 4c are interposed because one pattern, Pattern 600, exists in between two portions of the other pattern, Pattern 500. FIG. 4d illustrates independent multicolor patterns. The two patterns in FIG. 4d are independent because no portions of Pattern 700 intersect or interweave with Pattern 800, nor are the two patterns interposed with one another. Further it is to be understood that the present invention contemplates that different portions of the same multicolor patterns may be any combination of intersecting, interwoven or interposed.

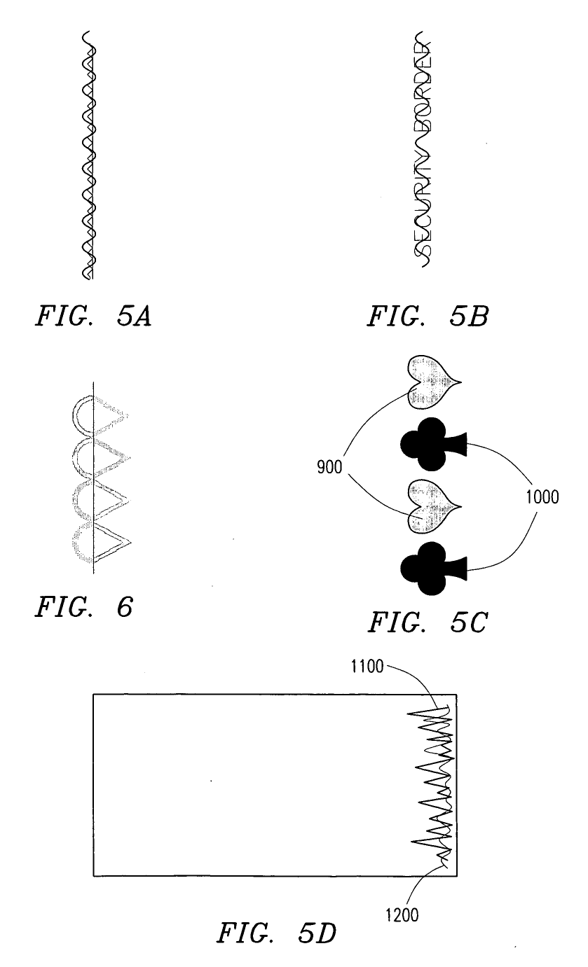

The multicolor patterns may be created in a number of different styles. FIGS. 1 and 4a illustrate multicolor patterns that are curvilinear and geometric. Curvilinear patterns encompass patterns made with curved lines or lines with curved and linear portions. Geometric patterns encompass patterns made with geometric shapes or straight lines. The present invention further contemplates patterns made from alphanumeric characters for example, microcharacters, as illustrated in FIG. 5b and with shapes, such as those shown in FIG. 5c. The multicolor patterns may be repeating (e.g., Patterns 100 and 200 in FIG. 4a) or non-repeating (e.g., Pattern 1100 and 1200 in FIG. 5d). Further the multicolor patterns may include varying line widths.

While the description with respect to FIGS. 1 through 5 is made with respect to patterns that comprise a single color throughout a particular pattern, it is to be understood that the present invention includes patterns where the color in the pattern changes. The color in the pattern can change gradually along the length of the pattern (see FIG. 6) through gradual differences in hue, saturation or value, or some combination thereof. The color in the pattern can also immediately change from one color to another. The changes in color in a pattern can also be repeated in the pattern.

The background color of the document in the border area can be a single color as shown in FIG. 1 or the background color can vary as shown in FIG. 3. The background color can change gradually in the border area through gradual differences in hue, saturation or value, or some combination thereof. The background color can also change immediately from one color to another. The background color can also have repeating patterns of colors.

The present invention further includes a method for enhancing security of a document and deterring copying of the document, comprising the steps of: designating a border area on a document; printing a first color pattern in the designated border area on the document, where the color of the first color pattern differs from the color of the document background; and printing at least one additional color pattern in the designated border area, where the color of the at least one additional color pattern differs from the background color and differs from the color of the first color pattern.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed as new and desired to be protected by Letters Patent of the United States is:

1. A document having enhanced security for deterring generation of copies of the document, comprising:
a border area with a background color;
a first pattern in the border area with a first pattern color that differs from the background color; and
a second pattern in the border area with a second pattern color that differs from the background color and differs from the first pattern color.

2. The document of claim 1, wherein the first pattern color, the second pattern color and the background color each differ from one another in hue, saturation, or value or a combination thereof.

3. The document of claim 1, further comprising a front face and a back face, wherein the border area is at least a portion of one edge on either the front face or back face of the document.

4. The document of claim 1, further comprising a front face and a back face, wherein the border area is at least a portion of each of two edges on either the front face or back face of the document.

5. The document of claim 4, wherein the two edges of the border area are adjacent edges of the document.

6. The document of claim 4, wherein the two edges of the border area are non-adjacent edges of the document.

7. The document of claim 1, further comprising a front face and a back face, wherein the border area is at least a portion of each of three edges on either the front face or back face of the document.

8. The document of claim 1, further comprising a front face and a back face, wherein the border area is at least a portion of each of four edges on either the front face or back face of the document.

9. The document of claim 1, wherein the first pattern is geometric, curvilinear, alphanumeric, shapes, or some combination thereof.

10. The document of claim 9, wherein the second pattern is geometric, curvilinear, alphanumeric, shapes, or some combination thereof.

11. The document of claim 1, wherein the first pattern is repeating.

12. The document of claim 11, wherein the second pattern is repeating.

13. The document of claim 1, wherein the first pattern has a line width and the line width varies in the first pattern.

14. The document of claim 13, wherein the second pattern has a line width and the line width varies in the second pattern.

15. The document of claim 1, wherein the first pattern and the second pattern are independent of one another.

16. The document of claim 1, wherein the first pattern intersects at least a portion of the second pattern.

17. The document of claim 1, wherein the first pattern is interwoven with at least a portion of the second pattern.

18. The document of claim 1, wherein the first pattern is interposed between the second pattern.

19. The document of claim 1, wherein the first pattern and second pattern are independent, intersecting, interwoven, or interposed, or some combination thereof.

20. The document of claim 1, wherein the first pattern color varies in hue, saturation, or value or a combination thereof along the length of the first pattern.

21. The document of claim 20, wherein the second pattern color varies in hue, saturation, or value or a combination thereof along the length of the second pattern.

22. The document of claim 1, wherein the background color varies in hue, saturation, or value or a combination thereof.

23. A document having enhanced security for deterring generation of copies of the document, comprising:
a front face and a back face;
a border area with a background color;
a first pattern in the border area with a first pattern color that differs from the background color; and
a second pattern in the border area with a second pattern color that differs from the background color and differs from the first pattern color.

24. The document of claim 23, wherein the border area is at least a portion of one edge on both the front face and the back face of the document.

25. The document of claim 23, wherein the border area is at least a portion of one edge on the front face of the document that has a background color and further comprising:
a second border area that is at least a portion of one edge on the back face of the document and having a second background color;
a third pattern in the second border area that is a third pattern color that differs from the first pattern color, the second pattern color, the background color, and the second background color;
a fourth pattern in the second border area that is a fourth pattern color that differs from the first pattern color, the second pattern color, the third pattern color, the background color, and the second background color.

26. The document of claim 25, wherein the background color and the second background color are the same color.

27. The document of claim 23, wherein the border area is at least a portion of each of two edges on both the front face and back face of the document.

28. The document of claim 23, wherein the border area is at least a portion of two edges on the front face of the document that has a background color and further comprising:
a second border area that is at least a portion of two edges on the back face of the document and having a second background color;
a third pattern in the second border area that is a third pattern color that differs from the first pattern color, the second pattern color, the background color, and the second background color;
a fourth pattern in the second border area that is a fourth pattern color that differs from the first pattern color, the second pattern color, the third pattern color, the background color, and the second background color.

29. The document of claim 28, wherein the background color and the second background color are the same color.

30. The document of claim 23, wherein the border area is at least a portion of each of three edges on both the front face and back face of the document.

31. The document of claim 23, wherein the border area is at least a portion of three edges on the front face of the document that has a background color and further comprising:
a second border area that is at least a portion of three edges on the back face of the document and having a second background color;
a third pattern in the second border area that is a third pattern color that differs from the first pattern color, the second pattern color, the background color, and the second background color;
a fourth pattern in the second border area that is a fourth pattern color that differs from the first pattern color, the second pattern color, the third pattern color, the background color, and the second background color.

32. The document of claim 31, wherein the background color and the second background color are the same color.

33. The document of claim 23, wherein the border area is at least a portion of each of four edges on both the front face and back face of the document.

34. The document of claim 23, wherein the border area is at least a portion of four edges on the front face of the document that has a background color and further comprising:
a second border area that is at least a portion of four edges on the back face of the document and having a second background color;
a third pattern in the second border area that is a third pattern color that differs from the first pattern color, the second pattern color, the background color, and the second background color;
a fourth pattern in the second border area that is a fourth pattern color that differs from the first pattern color, the second pattern color, the third pattern color, the background color, and the second background color.

35. The document of claim 34, wherein the background color and the second background color are the same color.

36. A method for enhancing the security of a document and deterring generation of copies of the document, comprising:
designating a border area with a background color;
printing a first pattern in the designated border area with a first pattern color that differs from the background color; and
printing a second pattern in the designated border area with a second pattern color that differs from the background color and differs from the first color.

37. The method of claim 36, wherein the first pattern color, the second pattern color and the background color each differ from one another in hue, saturation, or value or a combination thereof.

38. The method of claim 36, wherein the first pattern is geometric, curvilinear, alphanumeric, shapes, or some combination thereof.

39. The method of claim 38, wherein the second pattern is geometric, curvilinear, alphanumeric, shapes, or some combination thereof.

40. The method of claim 36, wherein the first pattern and second pattern are independent, intersecting, interwoven, or interposed, or some combination thereof.

41. The method of claim 36, wherein the first pattern color varies in hue, saturation, or value or a combination thereof along the length of the first pattern.

42. The method of claim 41, wherein the second pattern color varies in hue, saturation, or value or a combination thereof along the length of the second pattern.

43. The method of claim 36, wherein the background color varies in hue, saturation, or value or a combination thereof.
